(19) United States
(12) Patent Application Publication
(10) Pub. No.: US 2022/0277598 A1
(43) Pub. Date: Sep. 1, 2022

(54) DEVICES AND METHODS FOR COLLECTING TRAFFIC ACCIDENT INFORMATION

(71) Applicant: Huawei Technologies Co., Ltd., Shenzhen (CN)

(72) Inventor: Ming LIU, Shenzhen (CN)

(21) Appl. No.: 17/750,070

(22) Filed: May 20, 2022

Related U.S. Application Data
(63) Continuation of application No. PCT/EP2019/082181, filed on Nov. 22, 2019.

(51) Int. Cl. G07C 5/00; G07C 5/08; H04W 4/38; H04W 4/40; H04W 4/90

(52) U.S. Cl. CPC G07C 5/008; G07C 5/0808; G07C 5/0866; H04W 4/38; H04W 4/40; H04W 4/90

(57) ABSTRACT

A telematic control device for a vehicle comprises an accident detection device configured to detect an accident of the vehicle and a communication interface configured to transmit accident information via a wireless communication network to a cloud network entity in response to an accident detection signal from the accident detection device. The cloud network entity comprises a communication interface which receives, from at least one of the one or more vehicles, accident information of a first vehicle via a wireless communication network. The communication interface further provides the accident information to a police communication device for accident arbitration. The police communication device comprises: a communication interface which receives accident information of at least one of the one or more vehicles involved in an accident; and a display which displays the accident information, e.g. to a police officer. The techniques facilitate the gathering and processing of accident information.

### CROSS-REFERENCE TO RELATED APPLICATIONS

This application is a continuation of International Application No. PCT/EP2019/082181, filed on Nov. 22, 2019, the disclosure of which is hereby incorporated by reference in its entirety.

### TECHNICAL FIELD

The present disclosure relates to telecommunications in general. More specifically, the disclosure relates to a telemetric control device, a cloud network entity and a police communication device for collecting information about an accident involving one or more vehicles, and to corresponding methods.

### BACKGROUND

A traffic accident involving one or more vehicles often requires the police or other authority to dispatch personnel to the location of the accident. At the location, the personnel investigate the accident, for instance by interrogating witnesses. The results of these investigations may be used for the arbitration of an accident, in particular for determining who is accountable for the accident.

The arbitration of an accident with police personnel at the site of the accident can be a long and tedious procedure. It may include taking notes and recording declarations, and unblocking the traffic, for example. In case the traffic was blocked and needs to be unblocked quickly despite unclear liabilities, multiple accident participants may need to be further summoned to a police office for providing evidence or making declarations. In addition, in those cases where the evidence is provided only verbally and subjectively, the arbitration may be error prone.

Thus, the existing processes for dealing with traffic accidents have some drawbacks. For instance, the parties involved in an accident may have to wait until the police have dispatched personnel to the location of the accident. The traffic may be blocked for quite a while as the vehicles involved in the accident may not be moved until notes have been made and evidence has been collected. Moreover, dispatching police or other personnel to the site of the accident is costly. The arbitration result is mainly based on the testimony of the witnesses or a simple on-site accident analysis, and both tend to be unreliable.

### SUMMARY

It is an object of the disclosure to provide improved devices, systems and methods for traffic accident arbitration and handling.

The foregoing and other objects are achieved by the subject matter of the independent claims. Further implementation forms are apparent from the dependent claims, the description and the figures.

Generally, the disclosure provides a telematic control device for a vehicle, a cloud network entity and a police communication device. These three entities are configured to communicate via a wireless communication network, to provide remote traffic accident administration. The proposed technique allows recording of image data and vehicle data, for providing reliable accident information and quick site instructions, e.g. for clearing a blocked road. The technique may avoid a need for despatching police to the site of an accident.

More specifically, according to a first aspect the disclosure relates to a telematic control device for a vehicle, comprising: an accident detection device configured to detect an accident of the vehicle; and a communication interface configured to transmit accident information via a wireless communication network to a cloud network entity (e.g. for accident analysis, especially arbitration), in response to receiving an accident detection signal from the accident detection device. Advantageously, this allows for a remote arbitration of a traffic accident so that no police personnel must be dispatched to the site of the traffic accident. The accident detection device can be manually triggered by a user, i.e. a driver and/or passenger, of the vehicle or an accident can be detected automatically by the accident detection device for generating the accident detection signal. The accident detection device could be coupled for instance to an airbag sensor, an acceleration sensor or another type of sensor of the vehicle.

In a further possible implementation form of the first aspect, the telematic control device further comprises an image capturing unit configured to capture one or more images of an environment of the vehicle and wherein the accident information comprises the one or more images of the environment of the vehicle. Advantageously, this allows for a very accurate arbitration result. The image capturing unit can comprise, for instance, a dashboard camera of the vehicle. Advantageously, this allows for an easy integration of the telematic control device according to the first aspect into an already existing hardware infrastructure of a vehicle.

In a further possible implementation form of the first aspect, the one or more images comprise one or more video sequences of an environment of the vehicle prior, during and/or after the accident. Advantageously, this allows for a very accurate arbitration result.

In a further possible implementation form of the first aspect, the communication interface is further configured to provide the accident information, in particular the one or more images in an encrypted form via the wireless communication network to the cloud network entity for accident arbitration. Advantageously, in countries, where the accident information, in particular the one or more images are considered to be private data, this ensures a better protection of the private data.

In a further possible implementation form of the first aspect, the accident information comprises at least one of: speed data, time data, direction data, position data (e.g. Global Positioning System, GPS, data), airbag data, acceleration data, or seat occupancy data of the vehicle. Advantageously, this allows to provide an even more efficient and accurate accident arbitration. In an embodiment, the telematic control device comprises or is connected with one or more suitable sensors for obtaining the accident information.

In a further possible implementation form of the first aspect, the communication interface of the telematic control device is further configured to notify, in response to receiving the accident detection signal from the accident detection device, one or more further vehicles in the vicinity of the vehicle about the accident for triggering the one or more further vehicles to provide similar accident information obtained by the one or more further vehicles to the cloud network entity. Advantageously, this allows to provide an even more efficient and accurate accident arbitration.

In a further possible implementation form of the first aspect, the communication interface of the telematic control device is further configured to establish, in response to receiving the accident detection signal from the accident detection device, an eCall (emergency call) via the wireless communication network to an eCall network entity. Advantageously, this allows to efficiently couple the improved arbitration procedure implemented by the telematic control device according to the first aspect with an eCall procedure.

In a further possible implementation form of the first aspect, the communication interface of the telematic control device is further configured to receive a response message from the cloud network entity. The response message can comprise at least one of: voice communication, an arbitration result, commands, instructions. Advantageously, this allows for a more efficient handling of a traffic accident, because the traffic participants can be provided remotely with instructions, for instance, for clearing the road.

According to a second aspect the disclosure relates to a cloud network entity for arbitration of an accident involving one or more vehicles, wherein the cloud network entity comprises a communication interface configured to receive from at least one of the one or more vehicles accident information via a wireless communication network, wherein the communication interface is further configured to provide the accident information of the vehicle to a police communication device for accident arbitration. Advantageously, this allows for a remote arbitration of a traffic accident so that no police personnel must be dispatched to the site of the traffic accident.

In a further possible implementation form of the second aspect, the accident information comprises a plurality of images captured by at least one vehicle involved in the accident and/or one or more further vehicles in the vicinity of the at least one vehicle involved in the accident. Advantageously, this allows to provide an even more efficient and accurate accident arbitration.

In a further possible implementation form of the second aspect, the cloud network entity further comprises a processing circuitry configured to assign the plurality of images to a single accident. Advantageously, this allows the cloud network entity to assemble and archive all the images and other accident information associated with a given accident, in case these images and data have to be reviewed again.

In a further possible implementation form of the second aspect, the communication interface is further configured to establish, in response to receiving from at least one of the one or more vehicles the one or more images of an environment of the vehicle, an eCall between the vehicle and an eCall network entity via the wireless communication network. Advantageously, this allows to efficiently couple the improved arbitration procedure implemented by the cloud network entity according to the second aspect with an eCall procedure.

According to a third aspect the disclosure relates to a police communication device, for instance a mobile police communication device, for arbitration of an accident involving one or more vehicles. The police communication device comprises: a communication interface configured to receive accident information of at least one of the one or more vehicles involved in an accident; and a display configured to display the accident information to a police officer for arriving at an accident arbitration result. Advantageously, this allows for a remote arbitration of a traffic accident so that no police personnel need to be dispatched to the site of the traffic accident.

In a further possible implementation form of the third aspect, the accident information comprises at least one of: one or more images, speed data, time data, direction data, GPS data, airbag data, acceleration data, or seat occupancy data. Advantageously, this allows to provide an even more efficient and accurate accident arbitration.

In a further possible implementation form of the third aspect, the police communication device further comprises a user interface configured to receive the accident arbitration result arrived at by the police officer. Advantageously, this allows for an efficient remote management of a traffic accident.

In a further possible implementation form of the third aspect, the communication interface is further configured to provide the accident arbitration result to a cloud network entity for archiving the accident arbitration result and/or the accident information. Advantageously, this allows the cloud network entity to assemble and archive the accident information associated with a given accident together with the arbitration result, in case these data have to be reviewed again in the future.

In a further possible implementation form of the third aspect, the communication interface is further configured to provide the accident arbitration result to the one or more vehicles involved in the accident. Advantageously, this allows for a fast and efficient handling of the accident.

In a further possible implementation form of the third aspect, the user interface is further configured to receive one or more instructions from the police officer for resolving the accident. The communication interface can be further configured to provide the one or more instructions to a cloud network entity for forwarding the one or more instructions to the vehicles involved in the accident or directly to the vehicles involved in the accident. Advantageously, this allows for a more efficient handling of a traffic accident, because the traffic participants can be provided remotely with instructions, for instance, for clearing the road.

According to a fourth aspect the disclosure relates to a method for operating a telematic control device for a vehicle, wherein the method comprises the steps of: detecting an accident of the vehicle by an accident detection device of the vehicle; and transmitting accident information via a wireless communication network to a cloud network entity in response to an accident detection signal from the accident detection device. Advantageously, this allows for a remote arbitration of a traffic accident so that no police personnel must be dispatched to the site of the traffic accident.

The method according to the fourth aspect of the disclosure can be performed by the telematic control device according to the first aspect of the disclosure. Further features of the method according to the fourth aspect of the disclosure result directly from the functionality of the telematic control device according to the first aspect of the disclosure and its different implementation forms described above and below.

According to a fifth aspect the disclosure relates to a method for operating a cloud network entity for arbitration of an accident involving one or more vehicles, wherein the method comprises the steps of: receiving from at least one of the one or more vehicles accident information of the vehicle via the wireless communication network; and providing the accident information of the vehicle to a police communication device for accident arbitration. Advantageously, this allows for a remote arbitration of a traffic accident so that no police personnel must be dispatched to the site of the traffic accident.

The method according to the fifth aspect of the disclosure can be performed by the cloud network entity according to the second aspect of the disclosure. Further features of the method according to the fifth aspect of the disclosure result directly from the functionality of the cloud network entity according to the second aspect of the disclosure and its different implementation forms described above and below.

According to a sixth aspect the disclosure relates to a method of operating a police communication device for arbitration of an accident involving one or more vehicles, wherein the method comprises the steps of: receiving accident information of at least one of the one or more vehicles involved in an accident; and displaying the accident information on a display of the police communication device (e.g. to a police officer, for helping the police officer to arbitrate the accident). Advantageously, this allows for a remote arbitration of a traffic accident so that no police personnel must be dispatched to the site of the traffic accident.

The method according to the sixth aspect of the disclosure can be performed by the police communication device according to the third aspect of the disclosure. Further features of the method according to the sixth aspect of the disclosure result directly from the functionality of the police communication device according to the third aspect of the disclosure and its different implementation forms described above and below.

According to a seventh aspect the disclosure relates to a computer program product comprising a non-transitory computer-readable storage medium carrying program code which causes a computer or a processor to perform the method according to the fourth aspect, the method according to the fifth aspect and/or the method according to the sixth aspect when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

The following embodiments of the disclosure are described in more detail with reference to the attached figures and drawings, in which:

FIG. 1 is a schematic diagram illustrating an exemplary accident scenario involving a vehicle comprising a telematic control device according to an embodiment, which is in communication with a cloud network entity according to an embodiment and a police communication device according to an embodiment;

FIG. 2 is a schematic diagram illustrating a telematic control device according to an embodiment, which is in communication with a cloud network entity according to an embodiment and a police communication device according to an embodiment;

FIG. 3 is a flow diagram illustrating different steps for handling a traffic accident implemented by a telematic control device according to an embodiment, a cloud network entity according to an embodiment and a police communication device according to an embodiment;

FIG. 4 is a signaling diagram illustrating the signal flow in an accident scenario between a vehicle comprising a telematic control device according to an embodiment, a cloud network entity according to an embodiment and a police communication device according to an embodiment;

FIG. 5 is a signaling diagram illustrating the signal flow in an accident scenario between a vehicle comprising a telematic control device according to an embodiment, a cloud network entity according to an embodiment and a police communication device according to an embodiment;

FIG. 6 is a flow diagram illustrating a method of operating a telematic control device for a vehicle according to an embodiment of the disclosure;

FIG. 7 is a flow diagram illustrating a method of operating a cloud network entity for accident arbitration according to an embodiment of the disclosure; and

FIG. 8 is a flow diagram illustrating a method of operating a police communication device for accident arbitration according to an embodiment of the disclosure.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the disclosure or specific aspects in which embodiments of the disclosure may be used.

It is understood that embodiments of the disclosure may be used in other aspects and comprise structural or logical changes not depicted in the figures. The following detailed description, therefore, is not to be taken in a limiting sense.

For instance, it is to be understood that a disclosure in connection with a described method may also hold true for a corresponding device or system configured to perform the method and vice versa.

For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures.

On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

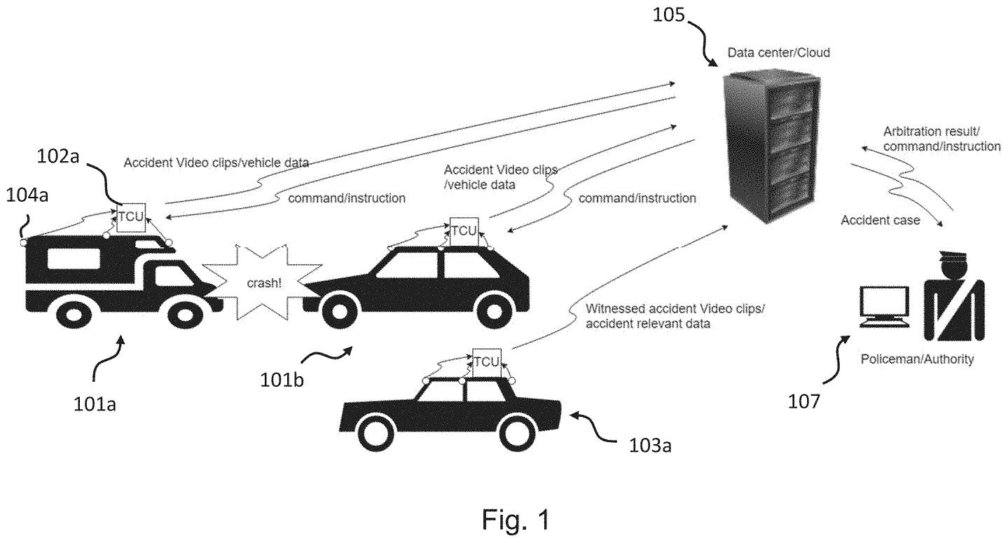

FIG. 1 is a schematic diagram illustrating an exemplary accident scenario involving two vehicles 101a, 101b. Both vehicles 101a, 101b comprise a telematic control device or unit, TCU (also known as telematics box or T-box), which for the vehicle 101a is referred to as TCU 102a. In the following embodiments of the disclosure will be described with respect to the TCU 102a of the vehicle 101a with the understanding that the TCU of the vehicle 101b can be configured to operate in the same way.

As will be described in more detail below, the TCU 102a of the vehicle 101a comprises an accident detection device configured to detect an accident of the vehicle 101a and a communication interface configured to transmit, in response to receiving an accident detection signal from the accident detection device, accident information via a wireless, in particular cellular communication network to a cloud network entity, such as a cloud data center 105 for accident arbitration.

According to an embodiment, the accident detection device can detect an accident by being triggered by a user, e.g. manually or by a voice command. The user may be a driver or other occupant of the vehicle 101a. According to another embodiment, the accident detection device is configured to detect an accident automatically. The accident detection device of the TCU 102a may be coupled for instance to an airbag sensor, an accelerometer sensor or another type of sensor of the vehicle. For enabling a user to trigger the accident detection device a user interface may be provided, such as an emergency button arranged on the dashboard of the vehicle (e.g. similar or identical to the emergency button for activating warning lights, e.g. left and right blinker lights).

The accident detection device of the TCU 102a of the vehicle 101a can be implemented in hardware and/or software. The hardware may comprise digital circuitry, or both analog and digital circuitry. Digital circuitry may comprise components such as application-specific integrated circuits (ASICs), field-programmable arrays (FPGAs), digital signal processors (DSPs), or general-purpose processors.

In one embodiment, the application detection device and/or the TCU 102a comprises one or more processors and a non-transitory memory connected to the one or more processors. The non-transitory memory may carry executable program code which, when executed by the one or more processors, causes the apparatus to perform the operations or methods described herein.

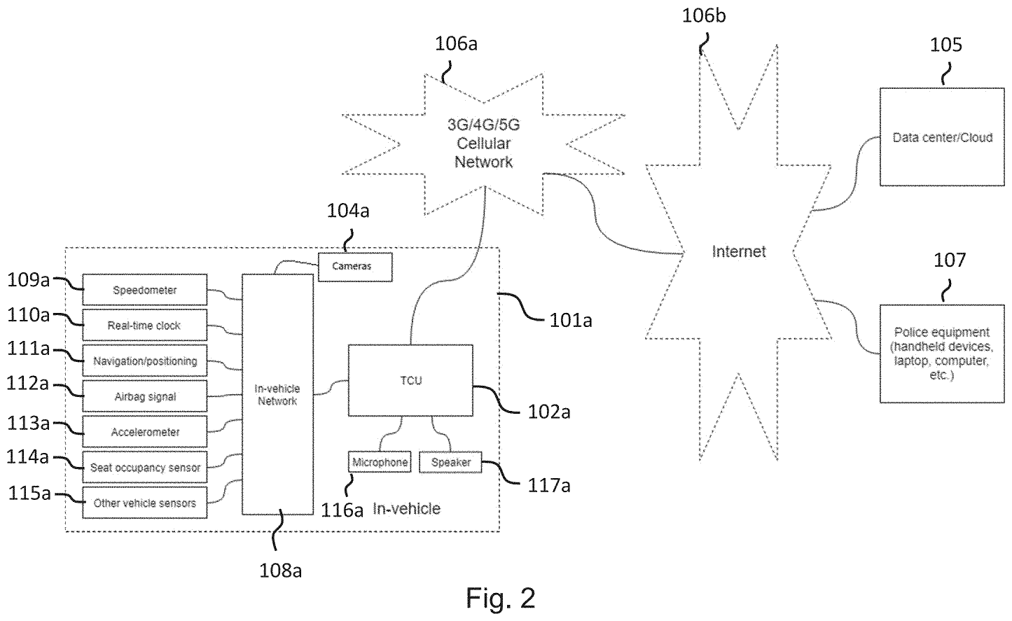

Still with reference to FIG. 2, the vehicle 101a can comprise a plurality of sensors, such as one or more image capturing units, in particular cameras 104a (also shown in FIG. 1, where the vehicle 101a by way of example is shown to have three cameras), including a dashboard camera, for capturing one or more images of the environment of the vehicle 101a, a speed sensor 109a for providing data about the speed of the vehicle 101a, a real-time clock 110a, a positioning sensor, such as a GPS sensor 111a for providing data about the position of the vehicle 101a, an airbag sensor 112a for providing data about the state of the airbags of the vehicle 101a, an accelerometer 113a for providing data about the acceleration of the vehicle 101a, a seat occupancy sensor 114a and/or other vehicle sensors 115a. At least some of these sensors can provide the accident information that is transmitted by the communication interface of the TCU 102a via the cellular communication network 106a to the cloud network entity 105 located in the cloud, i.e. the Internet 106b.

In an embodiment, the accident information can comprise at least one of: the velocity of the vehicle 101a shortly before the accident (from the speedometer 109a), which can be used for determining whether the vehicle 101a was over speeding or not shortly before the accident; the time when the accident happens (from the real-time clock 110a); the location information of the accident site and/or the vehicles 101a, 101b involved in the accident (from the navigation or other positioning sensors 111a); the deployment status of airbags (from the airbag sensors/signals 112a), which can be used for assessing the severity of the accident; the acceleration/deceleration information of the vehicle (from the accelerometer 113a), which can be used for assessing the reaction of the driver, such as full gas or full break; the occupancy status of vehicle seats (from the seat occupancy sensor 114a), which can be used for determining the total number of passengers in the vehicle 101a during the accident. Thus, this accident information can provide information in particular about the position, direction and/or other state variables of the vehicles 101a, 101b involved in the accident, which are helpful for reconstructing the accident and, therefore, for arriving at a correct arbitration result.

In the embodiment shown in FIG. 2 the different types of sensors are connected via an in-vehicle network 108a to the TCU 102a. In other embodiments, at least some of these sensors are implemented as a respective component of the TCU 102a. As illustrated in FIG. 2, the TCU 102a is further connected to a microphone 116a and a speaker 117a arranged in the vehicle 101a, e.g. for receiving voice commands from and/or providing information, such as information about the state of the vehicle 102a or information received from the cloud network entity 105, to a passenger of the vehicle 101a.

According to an embodiment, the one or more images captured by the camera(s) 104a and provided to the cloud network entity 105 comprise one or more video sequences of an environment of the vehicle 101a prior, during and/or after the accident. In an embodiment, the communication interface of the TCU 102a is configured to provide the accident information, including the one or more images provided by the camera(s) 104a in an encrypted form via the wireless communication network 106a to the cloud network entity 105 for accident arbitration.

The cloud network entity 105 comprises a communication interface configured to receive the accident information from the TCU 102a of the vehicle 101a (for example, via the wireless communication network 106a). According to an embodiment, the accident information includes the one or more images. The communication interface of the cloud network entity 105 is further configured to provide the accident information of the vehicle 101a to one or more police communication devices 107 for accident arbitration. The police communication devices 107 may comprise, for instance, a suitably configured handheld mobile device, such as a mobile phone, a laptop computer or a desktop computer.

In an embodiment, the communication interface of the cloud network entity 105 is configured to receive the accident information, in particular image/video sequences, from more than one vehicle involved in an accident, such as the vehicles 101a and 101b shown in FIG. 1, as well as from other vehicles in the vicinity of the accident, such as the vehicle 103a (referred to herein as witness vehicles).

In an embodiment, the cloud network entity 105 is further configured to assign the plurality of accident information, in particular image/video sequences received from the different vehicles 101a, 101b, 103a as a single accident and archive this data as a single accident for future access.

In order to provide the accident information from any nearby vehicles not directly involved in an accident, such as the vehicle 103a shown in FIG. 1, to the cloud network entity 105 as well, the communication interface of the TCU 102a of the vehicle 101a involved in the accident can be further configured to notify, in response to receiving the accident detection signal from its accident detection device, any vehicles in the vicinity of the vehicle 101a, such as the vehicle 103a, about the accident for triggering the vehicle 103a to provide similar accident information, in particular image/video sequences obtained by the vehicle 103a to the cloud network entity 105.

The police communication device(s) 107 comprises a communication interface configured to receive the accident information, in particular image/video sequences captured by the vehicle 101a as well as any other vehicles being involved in or having witnessed the accident, such as the vehicles 101b and 103a shown in FIG. 1, and a display configured to display this accident information to a user of the police communication device 107, e.g. a police officer. This allows the police officer immediately after the accident has happened to remotely review the accident information, in particular image sequences provided by the vehicles 101a, 101b and 103a, and to arrive at an accident arbitration result, such as determining whether in the exemplary accident scenario shown in FIG. 1 vehicle 101a or vehicle 101b has caused the accident.

In an embodiment, the police communication device 107 further comprises a user interface, such as a keyboard and/or a microphone, configured to receive the accident arbitration result arrived at by the police officer. In an embodiment, the communication interface of the police communication device 107 is further configured to provide the accident arbitration result to the cloud network entity 105 for archiving the accident arbitration result together with the accident information collected from the vehicles 101, 101b and 103a for future reference. The accident information archived by the cloud network entity 105 can be used for other purposes as well, for instance as the evidence used for an insurance payout or as statistical events for the governmental traffic department to improve the road or facility conditions in order to avoid further accidents, where an accident has happened.

In an embodiment, the user interface of the police communication device 107 is further configured to receive one or more instructions from the police officer for resolving the accident and to provide these instructions via the cloud network entity 105 to the vehicles 101a, 101b involved in the accident. Such instructions can comprise, for instance, instructions to the passengers of the vehicles 101a, 101b for clearing the road. Additionally or alternatively, the response message from the cloud network entity 105 to the vehicles 101a, 101b can comprise other types of voice communication and/or the arbitration result itself.

It should be noted that FIG. 1 presents a non-limiting example of the system. In another embodiment, the TCU 102a of the vehicle 101a may be configured to communicate with the police communication device(s) 107, and the police communication device(s) 107 is further configured to communicate with the cloud network entity 105 which is used for example to archive the accident information.

In this embodiment, the TCU 102a of the vehicle 101a for example is configured to provide the accident information, including the one or more images provided by the camera(s) 104a in an encrypted form via the wireless communication network 106a to the police communication device(s) 107, and the police communication device(s) 107 is configured to provide the accident information to the cloud network entity 105 for archiving. On the other hand, the police communication device(s) 107 may provide arbitration result to the TCU 102a of the vehicle 101a and provide the accident information collected from the vehicles for example 101, 101b and 103a for archiving. By this way, the TCU 102a of the vehicle 101a may communicate with the police communication device(s) 107 directly to reduce the latency of accident report and arbitration.

The following describes the embodiments based on FIG. 1 and/or FIG. 2, but it is non-limited to the FIG. 1 and/or FIG. 2.

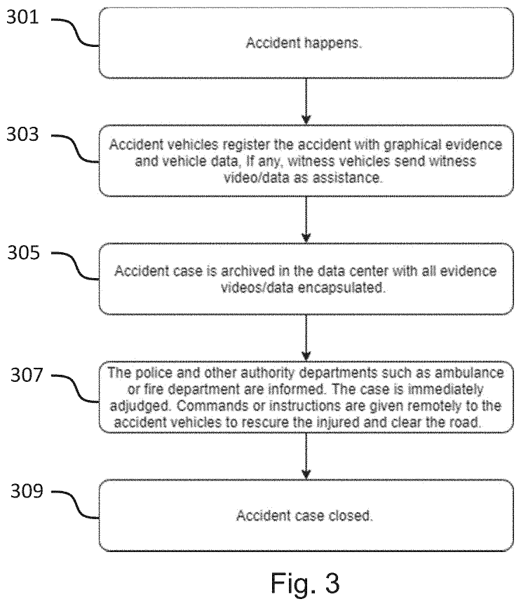

FIG. 3 summarizes some of the important aspects described above in the form of a flow diagram. Once an accident happens (see step 301 of FIG. 3), the vehicles 101a, 101b for example involved in the accident and any witness vehicles in the vicinity of the accident, for example vehicle 103a shown in FIG. 1, provide their accident information to the cloud network entity 105 (see step 303 of FIG. 3).

All accident information is archived in the cloud network entity 105, possibly in encrypted and/or encapsulated form (see step 305 of FIG. 3). The cloud network entity 105 informs the police communication device 107 about the accident and provides the collected accident information for remote arbitration of the accident.

Once the policer officer has reviewed the accident information using the police communication device 107, he/she inputs the arbitration result as well as any commands/instructions for the passengers of the vehicles 101a, 101b involved in the accident via the user interface of the police communication device 107 (see step 307 of FIG. 3). Thereafter, the case can be closed (see step 309 of FIG. 3).

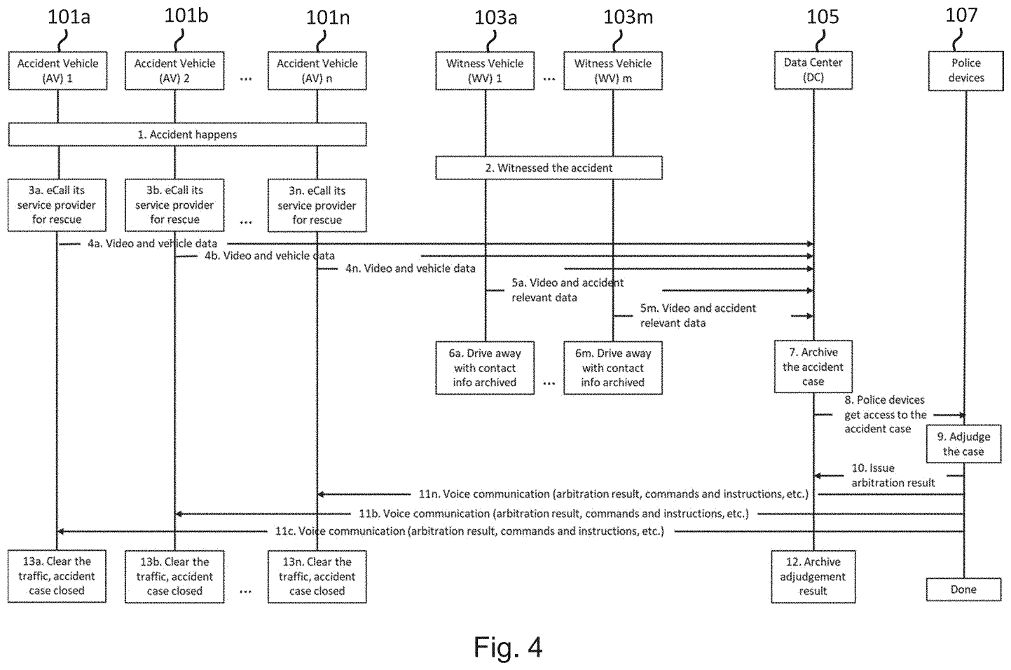

FIG. 4 shows a signaling diagram illustrating in more detail the signal flow in an exemplary accident scenario between the vehicles 101a-101n involved in the accident, the vehicles 103a-103m in the vicinity of the accident, the cloud network entity, e.g. data center 105 and the police communication device(s) 107.

When an accident happens to multiple accident vehicles 101a-101n, each accident vehicle can connect to its service provider with an eCall asking for rescuing injured people and damaged vehicles. The eCall can be individually conducted, mainly based on the fact that these accident vehicles 101a-101n may have different eCall service providers which are not managed in a unified way.

The steps of FIG. 4 is as follows:

Step 1: An accident happens involving the accident vehicles 101a-101n.

Step 2: The accident is witnessed by one or more witness vehicles 103a-103m.

Steps 3a-3n: Each accident vehicle 101a-101n connects to its service provider with an eCall asking for rescue.

Steps 4a-4n: All accident vehicles 101a-101n may send image/video data/evidence and/or other vehicle data, i.e. accident information collected during the accident to the cloud network entity, e.g. data center (DC) 105.

Steps 5a-5m: Any witness vehicles 103a-103m may send video and accident relevant data, i.e. accident information to the data center 105 in case of any witness vehicles 103a-103m seeing the accident and passing by the site. The video and accident relevant data, i.e. accident information may include, for instance, videos of the accident obtained by the witness vehicle(s) 103a-103m, radar and/or lidar data about the positions of the accident vehicle(s) 101a-101n relative to the witness vehicle(s) 103a-103m during the accident and contact information of the driver(s) of the witness vehicle(s) 103a-103m in case the police needs to contact the driver(s) of the witness vehicle(s) 103a-103m in the future.

According to an embodiment, the vehicle data and/or the accident relevant data, i.e. accident information can contain the geographical location information of the respective vehicle, by which the data center 105 can sort the data and assign those with a location close to each other to the same accident, as already described above.

Steps 6a-6m: Once the witness vehicles 103a-103m have provided the video and accident relevant data, in particular its contact information, to the data center 105, the witness vehicles 103a-103m can drive away for clearing the accident site.

Step 7: The cloud network entity, e.g. data center 105 will then archive the accident case and inform the police about the accident using the police communication device(s) 107.

Steps 8 to 10: With all accident information stored in the data center 105, the police can then using the police communication device(s) 107 access the data (step 8), adjudge the accident liabilities (step 9) and transmit the accident arbitration result back to the data center 105 (step 10).

Steps 11a-11n: By using the communication channels set up between the police communication devices 107 and the accident vehicles 101a-101n, the police may issue voice-based commands or instructions to all accident participants through the police communication devices 107, coordinating them to clear the road and to recover the traffic as soon as possible. Moreover, the police communication devices 107 can share the arbitration result with the accident vehicles 101a-101n.

Step 12: The arbitration result will be archived together with the other accident data/information in the data center 105 as a single accident for future reference.

Steps 13a-13n: Once the accident vehicles 101a-101n have received the voice communication from the police communication device(s) 107, including, for instance, the arbitration result, commands and/or instructions, the accident vehicles 101a-101n can drive away for clearing the accident site. The accident case then can be closed.

In the embodiment shown in FIG. 4, the eCall service is individually conducted by each accident participant, i.e. the vehicles 101a-101n. Each vehicle 101a-101n has the flexibility of choosing various eCall services and making its own decision whether to use an eCall or not, depending on the severity of the human injury or vehicle damage. In this case, the accident rescuing is a process independent from the liability arbitration described herein.

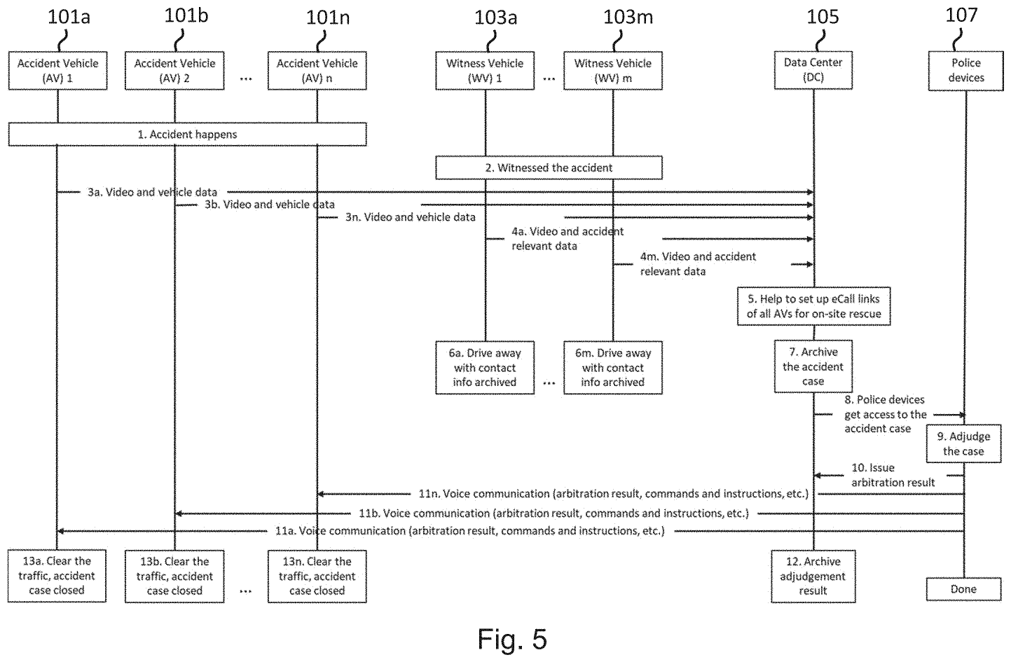

In the embodiment shown in FIG. 5, which is very similar to FIG. 4 described above, the eCall function is centrally managed and merged into the accident arbitration system shown, for instance, in FIGS. 1 and 2.

With the vehicle data reported for the accident, the cloud network entity, e.g. data center 105 may assist in setting up eCall links between the accident vehicles 101a-101n and their respective service provider, if necessary (see step 5 in FIG. 5). In other words, in the embodiment shown in FIG. 5 the accident vehicles 101a-101n do not need to individually contact their service provider for a rescue request (as in steps 3a-3n of FIG. 4). For the other steps shown in FIG. 5 reference is made to the above description of the corresponding identical steps of FIG. 4.

If the accident vehicles 101a-101n communicate directly with the police communication device 107, the police communication device 107 will initiate the eCall for each accident vehicles instead of data center 105.

As already mentioned above, in the embodiment shown in FIG. 5 the eCall service is incorporated into the accident arbitration system illustrated, for instance, in FIGS. 1 and 2. Whether an eCall is needed or not can depend, for instance, on the severity of the human injury or vehicle damage. It can be done automatically by machines, according to some criteria providing an objective measure on the severity of the human injury or vehicle damage, such as a vital sign monitoring of the passengers or diagnosis data of the vehicle, or by human beings who watch the accident video and make the judgement. The advantage of this approach is that, there is no need for the accident participants to do it on their own.

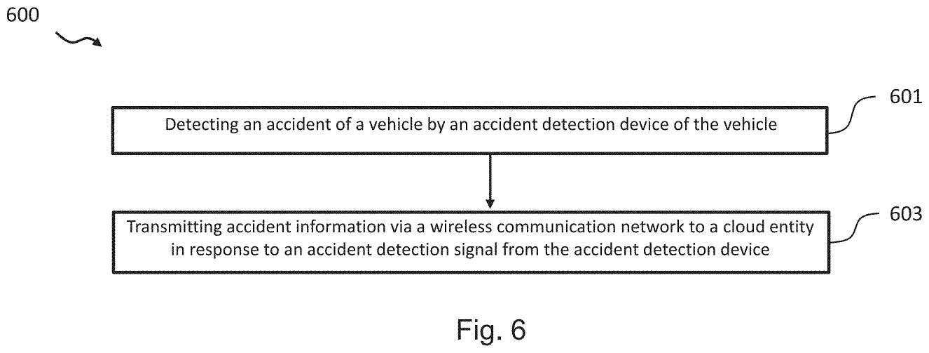

FIG. 6 is a flow diagram illustrating a method 600 of operating the TCU 102a of the vehicle 101a according to an embodiment of the disclosure. As described in greater detail in the context of the previous figures, the method 600 comprises the steps of: detecting 601 an accident of the vehicle 101a by an accident detection device of the vehicle; and transmitting 603 accident information via the wireless communication network 106a to the cloud network entity 105 in response to an accident detection signal from the accident detection device.

Similarly, in another embodiment, the method may comprises the steps of: detecting 601 an accident of the vehicle 101a by an accident detection device of the vehicle; and transmitting 603 accident information via the wireless communication network 106a to the police communication device 107 in response to an accident detection signal from the accident detection device.

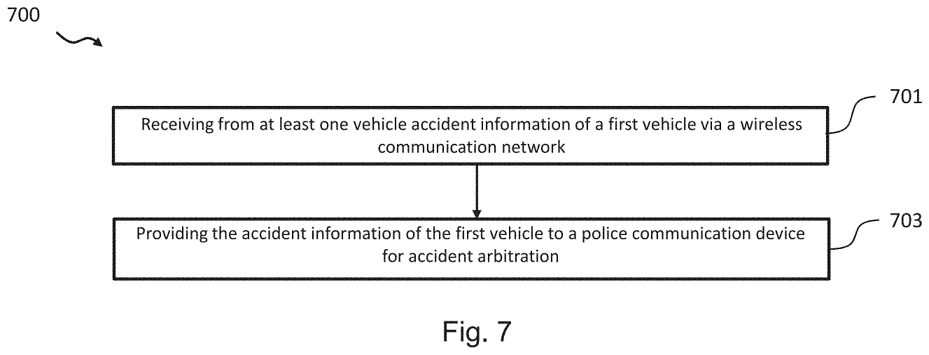

FIG. 7 is a flow diagram illustrating a method 700 of operating the cloud network entity, e.g. data center 105 for accident arbitration according to an embodiment of the disclosure. The method 700 comprises the steps of: receiving 701 from the vehicle 101a accident information of the vehicle 101a via the wireless communication network 106a; and providing the accident information of the vehicle 101 to one or more police communication devices 107 for accident arbitration.

In another embodiment, the method may comprise: receiving from the police communication device 107 accident information of the vehicle 101a; and archiving the accident information of the vehicle in the cloud network entity.

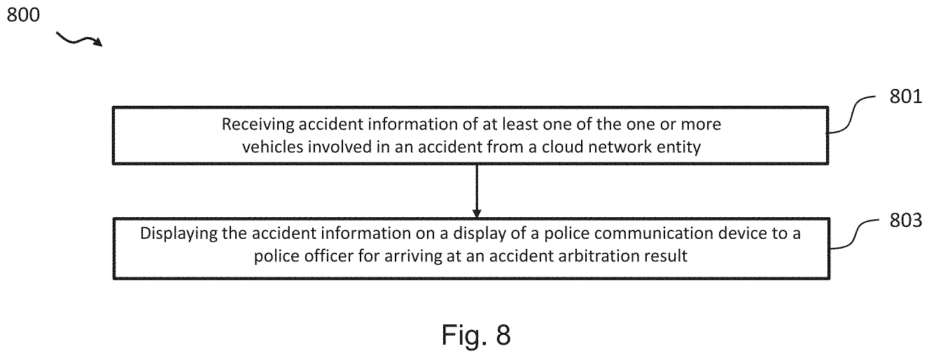

FIG. 8 is a flow diagram illustrating a method 800 of operating the police communication device 107 for accident arbitration according to an embodiment of the disclosure. The method 800 comprises the steps of: receiving 801 accident information of the vehicle 101a involved in the accident; and displaying the accident information on a display of the police communication device 107 to a police officer for arriving at an accident arbitration result.

In another embodiment, the method may comprise: receiving accident information from the vehicles involved in the accident; and providing the accident information of the vehicles involved in the accident to the cloud network entity 105.

Embodiments of the disclosure allow to record images associated with an accident and send this data and/or other accident information to the cloud network entity 105 using in-vehicle telematics connections. All this information can be used as the evidence of the traffic accident, used by the traffic regulation authorities to arbitrate and handle the accident quickly and remotely.

Thus, embodiments of the disclosure not only improve the work efficiency by avoiding dispatching policemen to the accident site, but also allow an immediate handling of an accident as well as an increases correctness of the arbitration results with solid archived accident evidence from various view angles provided by multiple accident parties.

The person skilled in the art will understand that the “blocks” (“units”) of the various figures (method and apparatus) represent or describe functionalities of embodiments of the disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units are integrated into one unit.

Some aspects of the disclosure provides a method, and a program code that when executed by a computer or a processor causes the computer or the processor to perform the method, for operating a telematic control device for a vehicle, wherein the method comprises: detecting an accident of the vehicle by an accident detection device of the vehicle; and transmitting accident information via a wireless communication network to a loud network entity for accident arbitration in response to an accident detection signal from the accident detection device.

Some aspects of the disclosure provides a method, and a program code that when executed by a computer or a processor causes the computer or the processor to perform the method, for operating a cloud network entity for arbitration of an accident involving one or more vehicles, wherein the method comprises: receiving from at least one of the one or more vehicles accident information of a first vehicle via a wireless communication network; and providing the accident information of the first vehicle to a police communication device.

Some aspects of the disclosure provides a method, and a program code that when executed by a computer or a processor causes the computer or the processor to perform the method, of operating a police communication device for arbitration of an accident involving one or more vehicles, wherein the method comprises: receiving accident information of at least one of the one or more vehicles involved in an accident; and displaying the accident information on a display of the police communication device.

What is claimed is:

1. A telematic control device for a vehicle, the telematic control device comprising:
an accident detection device configured to detect an accident of the vehicle; and
a communication interface configured to transmit accident information via a wireless communication network to a cloud network entity in response to an accident detection signal from the accident detection device.

2. The telematic control device of claim 1, further comprising:
an image capturing device configured to capture one or more images of an environment of the vehicle, wherein the accident information comprises the one or more images.

3. The telematic control device of claim 2, wherein the one or more images comprise one or more video sequences of an environment of the vehicle prior, during, and/or after the accident of the vehicle.

4. The telematic control device of claim 1, wherein the accident information comprises at least one of: speed data, time data, direction data, position data, airbag data, acceleration data, or seat occupancy data.

5. The telematic control device of claim 1, wherein the communication interface is further configured to notify, in response to the accident detection signal from the accident detection device, one or more further vehicles of the vehicle about the accident for triggering the one or more further vehicles to provide further accident information obtained by the one or more further vehicles to the cloud network entity for accident arbitration.

6. The telematic control device of claim 2, wherein the communication interface is further configured to provide the one or more images in an encrypted form via the wireless communication network to the cloud network entity for accident arbitration.

7. The telematic control device of claim 1, wherein the communication interface is further configured to establish, in response to the accident detection signal from the accident detection device, an emergency call (eCall) via the wireless communication network to an eCall network entity.

8. The telematic control device of claim 1, wherein the communication interface is further configured to receive a response message from the cloud network entity.

9. The telematic control device of claim 8, wherein the response message comprises at least one of: voice communication, an arbitration result, commands, or instructions.

10. A cloud network entity for arbitration of an accident involving one or more vehicles, wherein the cloud network entity comprises:
a communication interface configured to:
receive, from at least one vehicle of the one or more vehicles, accident information of an accident of a first vehicle via a wireless communication network; and
transmit the accident information of the first vehicle to a police communication device for accident arbitration.

11. The cloud network entity of claim 10, wherein the accident information of the first vehicle comprises a one or more images captured by one or more vehicles involved in the accident and/or one or more witness vehicles of the accident.

12. The cloud network entity of claim 11, wherein the cloud network entity further comprises processing circuitry configured to assign the one or more images to a single accident.

13. The cloud network entity of claim 10, wherein the communication interface is further configured to establish, in response to receiving, from the at least one vehicle, one or more images of an environment of the at least one vehicle, an emergency call (eCall) between the at least one vehicle and an eCall network entity via the wireless communication network.

14. A police communication device for arbitration of an accident involving one or more vehicles, wherein the police communication device comprises:
a communication interface configured to receive accident information from at least one vehicle of the one or more vehicles involved in an accident; and
a display configured to display the accident information to a police officer for arriving at an accident arbitration result.

15. The police communication device of claim 14, wherein the accident information comprises at least one of: one or more images, speed data, time data, direction data, global positioning system (GPS) data, airbag data, acceleration data, or seat occupancy data.

16. The police communication device of claim 14, wherein the police communication device further comprises a user interface configured to receive the accident arbitration result arrived at by the police officer.

17. The police communication device of claim 16, wherein the communication interface is further configured to provide the accident arbitration result to a cloud network entity for archiving at least one of the accident arbitration result or the accident information.

18. The police communication device of claim 16, wherein the communication interface is further configured to provide the accident arbitration result to the one or more vehicles involved in the accident.

19. The police communication device of claim 17, wherein the communication interface is further configured to receive one or more instructions from the police officer for resolving the accident.

20. The police communication device of claim 19, wherein the communication interface is further configured to provide the one or more instructions to the one or more vehicles involved in the accident.
